(19) United States
(12) Patent Application Publication
(10) Pub. No.: US 2005/0169465 A1
(43) Pub. Date: Aug. 4, 2005

(54) Data compression method, data decompression method, data conversion method and program for same

(75) Inventor: Noriko Itani, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/963,785

(22) Filed: Oct. 14, 2004

(30) Foreign Application Priority Data
Jan. 30, 2004 (JP) 2004-22822

(51) Int. Cl. H04L 9/00

(52) U.S. Cl. 380/42

(57) ABSTRACT

A data compression method, to generate a compressed data stream from an uncompressed data stream, enhances the secrecy of data compression. A scramble value is appended to the beginning of the uncompressed data stream, and a dynamic variable-length encoding method is used to perform data compression. Compressed data with high randomness can be generated, and data for processing can easily be randomized. That is, there is no need to share a common initial value on the generating side and on the restoring side, processing is simple, and the processing time can be shortened.

### CROSS-REFERENCE TO RELATED APPLICATIONS

This application is based upon and claims the benefit of priority from the prior Japanese Patent Application No. 2004-022822, filed on Jan. 30, 2004, the entire contents of which are incorporated herein by reference.

### BACKGROUND OF THE INVENTION

1. Field of the Invention

This invention relates to a data compression method, data decompression method, data conversion method and program to electronically store or transmit data, and in particular relates to a data compression method, data decompression method, data conversion method and program with improved data secrecy.

2. Description of the Related Art

As character codes, image data, and various other types of data have come to be handled by computers in recent years, the volume of data handled has also expanded. When electronically storing or transmitting data, it is useful to compress the data before storage or transmission.

On the other hand, the spread of the Internet and portable terminals has been accompanied by increasing awareness of security issues in data storage and communication. In this respect, encryption technologies are useful. Encryption methods may be broadly divided into stream encryption and block encryption; block encryption, with its simpler implementation, is the mainstream.

In block encryption, a mechanism is employed in which the data is divided into a bit size determined in advance, and encryption is performed for each such divided block. Consequently the encrypted data generated from two different blocks with exactly the same content are exactly the same, so that if care in use is not taken, secrecy may be degraded.

In order to enhance secrecy, in the technology of the prior art, a CBC (Cipher Block Chaining) mode has been proposed, in which the previous block in a chain is used to randomize the succeeding block, as shown in FIG. 27 (see for example the non-patent references Angou Gijutsu Nyumon (Hiroshi Yuuki, Softbank Publishing) and Practical Cryptography (Bruce Schneier and Niels Ferguson, John Wiley & Sons)).

That is, as shown in FIG. 27, in CBC encryption an initial value (initialization vector) is prepared to randomize the leading block, and the leading block of the plaintext divided into blocks is randomized by an XOR operation, and then encrypted to create an encrypted block.

After randomizing by an XOR operation on this encrypted block and the next plaintext block, encryption is performed, and the next encrypted block is created. Subsequent plaintext blocks are similarly encrypted.

In CBC decryption, the same initial value (initialization block) as in encryption is prepared, and after decrypting the leading encrypted block, XOR or another operation is used to cancel the randomization and obtain the original plaintext block.

The result of decrypting this leading encrypted block and the next encrypted block is subjected to an XOR operation or similar to cancel the randomization, and obtain the next plaintext block 2. Subsequent decryption of encrypted blocks is similarly performed.

Thus because encryption alone is easy to decipher, by randomizing the data and encrypting the data after randomizing, secrecy is improved.

On the other hand, a method has been proposed in which, after data compression, dummy data is added to the compressed data, and the entirety of the compressed data with dummy data added is then encrypted (see for example Japanese Patent Laid-open No. 10-121753 and PCT No. WO 00/52684).

The above convention method uses the preceding block in chainlike fashion to randomize the succeeding block, so as to improve the secrecy of the encryption; but an initial value for use in randomizing the leading block is necessary, and the initial value must be shared on the generating side and on the decompression side.

Further, because there is a high load even during encryption processing alone, there is the problem that randomization processing is increased, and that more processing time is required.

Because the latter technology of the prior art is in essence a method of appending compressed data to the randomization initial value of the former conventional technology, a similar problem arises.

### SUMMARY OF THE INVENTION

Hence an object of this invention is to provide a data compression method, data decompression method, data conversion method and program to maintain encryption secrecy, even when an initial value is not shared by the generating side and decompression side.

A further object of this invention is to provide a data compression method, data decompression method, data conversion method and program to reduce the processing time for encryption, while maintaining encryption secrecy.

Still another object of this invention is to provide a data compression method, data decompression method, data conversion method and program to reduce the processing time even when the encryption strength is increased.

In order to achieve these objects, a data compression method of this invention has a step of adding a scramble value of a prescribed bit length to the beginning of an input uncompressed data stream, and a step of compressing the uncompressed data stream with the above scramble value added to the beginning using a dynamic variable-length encoding method.

Further, a data decompression method of this invention has a step of decompressing the above compressed data stream using the above dynamic variable-length encoding method, and a step of removing the scramble value at the beginning of the above decompressed data stream and storing the above uncompressed data.

A data compression program of this invention has program data to add a scramble value of a prescribed bit length to the beginning of an input uncompressed data stream, and program data to compress the uncompressed data stream with the above scramble value added to the beginning using a dynamic variable-length encoding method.

It is preferable that a data compression method of this invention further have a step of acquiring the data size of the above uncompressed data stream or of the above uncompressed data stream with added scramble value, and a step of adding the above acquired data size to the above uncompressed data stream with added scramble value.

It is preferable that a data decompression method of this invention have a step of removing the above data size from the above compressed data stream; a step of decompressing the above compressed data stream with data size removed using the above dynamic variable-length encoding method; a step of removing the added scramble value of the above decompressed data stream; a step of calculating the data size of the above decompressed data stream or of the above compressed data stream; a step of comparing the above removed data size with the above calculated data size; and a step of removing the above scramble value and outputting the decompressed data, according to the above comparison result.

It is preferable that a data compression method of this invention further have a step of acquiring the beginning portion of the above compressed data stream; a step of taking the exclusive logical sum of the above acquired beginning portion of the compressed data stream and a key of a prescribed bit length; and a step of substituting the data stream calculated by the above exclusive logical sum operation for the beginning portion of the above compressed data stream.

It is preferable that a data decompression method of this invention have a step of acquiring the beginning portion of the above compressed data stream; a step of taking the exclusive logical sum of the above acquired beginning portion of the compressed data stream with a key of a prescribed bit length; a step of substituting the data stream calculated by the above exclusive logical sum operation for the beginning portion of the above compressed data stream; a step of decompressing the above substituted compressed data stream using the above dynamic variable-length encoding method; and a step of removing the scramble value at the beginning of the above decompressed data stream, to decompress the above uncompressed data.

It is preferable that a data compression method of this invention further have a step of acquiring the beginning portion of, or all of, the above compressed data stream; a step of encrypting the above acquired portion of, or all of, the compressed data stream by using a key of prescribed bit length; and a step of substituting the above data stream obtained by encryption for the beginning portion of, or all of, the above compressed data stream.

It is preferable that a data decompression method of this invention have a step of acquiring the beginning portion of, or all of, the above compressed data stream; a step of deciphering the above acquired beginning portion of, or all of, the compressed data stream by using a key of prescribed bit length; a step of substituting the above deciphered data stream for the above beginning portion of, or all of, the compressed-data stream; a step of decompressing the above substituted compressed data stream using the above dynamic variable-length encoding method; and a step of removing the scramble value at the beginning of the above decompressed data stream, and restoring the above uncompressed data.

It is preferable that a data compression method of this invention further have a step of taking the exclusive logical sum of the above beginning portion of the compressed data stream substituted for the above beginning portion and the above key, to perform conversion into the original compressed data stream; a step of acquiring the beginning portion of the above original compressed data stream after the above conversion; a step of taking the exclusive logical sum of the beginning portion of the above acquired compressed data stream and another key of prescribed bit length; and a step of substituting the above data stream obtained by the exclusive logical sum operation for the beginning portion of the above original compressed data stream.

It is preferable that a data compression method of this invention further have a step of deciphering the above beginning portion of the above compressed data stream with beginning portion substituted, and of converting into the original compressed data stream using a key of prescribed bit length; a step of acquiring the beginning portion of the above converted original compressed data stream; a step of encrypting the above acquired beginning portion of the compressed data stream by using another key of prescribed bit length; and a step of substituting the above data stream obtained by encryption for the beginning portion of the above original compressed data stream.

It is preferable that in a data compression method of this invention, the above compression step has a step of generating the above compressed data according to a code table for compression, and a step of updating the above code table according to the above compressed data stream.

It is preferable that in a data compression method of this invention, the above code table has a splay tree configuration.

It is preferable that in a data decompression method of this invention, the above expansion step has a step of generating the above expansion data according to a code table for expansion, and a step of updating the above code table according to the above decompressed data stream.

It is preferable that in a data decompression method of this invention, the above code table has a splay tree configuration.

In this invention, a scramble code is added to the beginning of the uncompressed data stream, and a dynamic variable-length encoding method is used to perform data compression; consequently compressed data with high randomness can be generated, and data for processing can be randomized by simple means. That is, there is no need to share a common initial value on the generating side and on the restoring side, and moreover processing is simple, so that this invention is effective for shortening of processing time.

### BRIEF DESCRIPTION OF THE DRAWINGS

FIG. 1 is a functional block diagram of a first aspect of a data compression method of this invention;

FIG. 2 is a functional block diagram of a first aspect of a data decompression method of this invention;

FIG. 3 explains the data compression operation in FIG. 1;

FIG. 4 explains the compression processing in FIG. 1;

FIG. 5 explains static variable-length encoding processing in FIG. 4;

FIG. 6 explains dynamic variable-length encoding processing in FIG. 4, appropriate to this invention;

FIG. 7 is a functional block diagram of a first specific example of the data compression method of FIG. 1;

FIG. 8 is a functional block diagram of a first specific example of the data decompression method of FIG. 2;

FIG. 9 is a first explanatory diagram of the dynamic Huffman encoding of FIG. 7;

FIG. 10 is a second explanatory diagram of the dynamic Huffman encoding of FIG. 7;

FIG. 11 is a third explanatory diagram of the dynamic Huffman encoding of FIG. 7;

FIG. 12 is a fourth explanatory diagram of the dynamic Huffman encoding of FIG. 7;

FIG. 13 is a functional block diagram of a second specific example of the data compression method of FIG. 1;

FIG. 14 is a functional block diagram of a second specific example of the data decompression method of FIG. 2;

FIG. 15 is a first explanatory diagram of the splay encoding of FIG. 13;

FIG. 16 is a second explanatory diagram of the splay encoding of FIG. 13;

FIG. 17 is a functional block diagram of a second aspect of a data compression method of this invention;

FIG. 18 is a functional block diagram of a second aspect of a data decompression method of this invention;

FIG. 19 is a functional block diagram of a third aspect of a data compression method of this invention;

FIG. 20 is a functional block diagram of a third aspect of a data decompression method of this invention;

FIG. 21 is a functional block diagram of a first specific example of the data compression method of FIG. 19;

FIG. 22 is a functional block diagram of a first specific example of the data decompression method of FIG. 20;

FIG. 23 is a functional block diagram of a second specific example of the data compression method of FIG. 19;

FIG. 24 is a functional block diagram of a second specific example of the data decompression method of FIG. 20;

FIG. 25 is a functional block diagram of a first aspect of key re-application processing to which a data compression method of this invention is applied;

FIG. 26 is a functional block diagram of a second aspect of key re-application processing to which a data compression method of this invention is applied; and, FIG. 27 explains the conventional CBC mode.

### DESCRIPTION OF THE PREFERRED EMBODIMENTS

Below, aspects of this invention are explained in the order of the first aspect, details of the compression method, second aspect, third aspect, fourth aspect, and other aspects; however, this invention is not limited to these aspects.

First Aspect

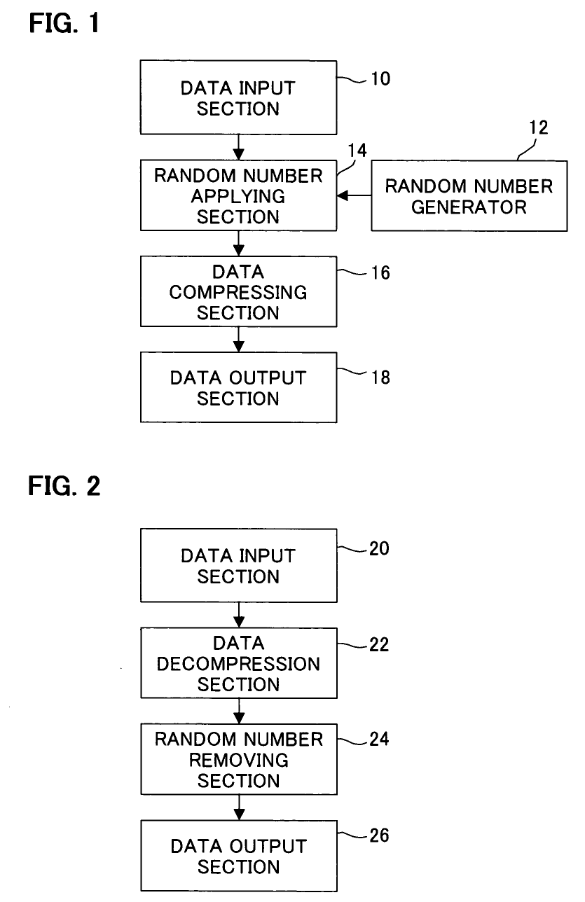

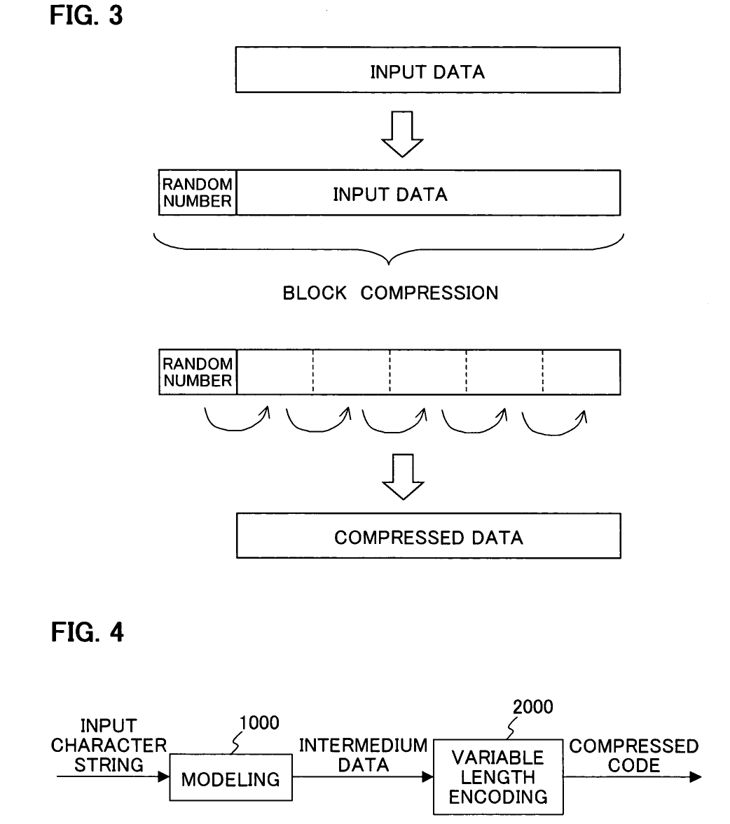

FIG. 1 is a functional block diagram of a first aspect of a data compression method of this invention, FIG. 2 is a functional block diagram of a first aspect of a data decompression method of this invention, FIG. 3 explains the data compression operation in FIG. 1, and FIG. 4 through FIG. 6 explain a compression method used in this invention.

FIG. 1 and FIG. 2 show functional blocks of the data compression/decompression methods, which are realized in hardware or by a program. As shown in FIG. 1, the generating side (compression side) has a data input portion 10, random number generation portion 12, random number appending (adding) portion 14, compression portion 16, and data output portion 18.

The random number appending portion 14 appends (adds) a random number generated by the random number generation portion 12 to the beginning of the data for processing from the data input portion 10. The data for processing, including the random number, is compressed by the compression portion 16 and output from the data output portion 18.

As shown in FIG. 3, a scramble value (for example, a random number) of a bit length determined in advance or of a specified arbitrary bit length is appended to the beginning of the (input) data for processing, and while compressing the data for processing, including the appended scramble value, the compression code table is updated according to the compressed data (below, compressed data which has been compressed with a scramble value added is called “scrambled compressed data”).

By this means, the effect of data toward the beginning affects the updating of the compression code for subsequent data. By thus using compression which generates data with high randomness, the data for processing can be randomized.

On the other side, as shown in FIG. 2, the decompression side has a data input portion 20, compressed data expansion portion 22, random number removal portion 24, and data output portion 26. Compressed data input from the data input portion 20 is expanded by the expansion portion 22, the random number at the beginning is removed by the random number removal portion 24, and the resulting data is output from the output portion 26. These random numbers are of a bit length determined in advance or of a bit length specified from outside.

In the above aspect, a random number is generated and appended; but the value appended to the beginning of the data for processing may be any value, although a non-arbitrary value is preferable.

In this way, compressed data with high randomness can be generated by data compression, and the data for processing can easily be randomized. That is, there is no need to share a common initial value on the generating side and on the decompression side, and there are the further advantageous results that processing is simple and processing time is shortened.

The above compression method is here explained. FIG. 4 explains a preferred loss-less compression method of this invention. A loss-less compression method is a compression method which is loss-less (not involving loss of information), enabling complete decompression of the original data.

As loss-less compression methods, (a) dictionary-based universal compression methods, and (b) statistical-type adaptive code compression methods, are often used. In the discussion below, following the nomenclature of information theory, one word of input data shall be called a “character”, and a data stream shall be called a “character string”.

The compression methods of (a) have a dictionary of character strings which have appeared in the past, and using the position in the dictionary and a dictionary registration number to express character strings which have already appeared. The compression methods of (b) perform encoding by assigning shorter codes to character strings which are more likely to appear, based on the probability of appearance of character strings which have appeared in the past. These methods generally consist of two stages, as shown in FIG. 4, and achieve high compression ratios.

That is, in the “modeling” stage 1000, lengths of repetition of the same character, combinations of the position of appearance of the same character string in the past and its length, the group numbers of immediately preceding characters when character types are grouped in advance, and characters for which regularity cannot be specified, are output as intermediate data.

In the “variable-length encoding” stage 2000, the higher the probability of appearance of a character in the input intermediate data, the shorter the code word assigned. In the intermediate data, single characters are of fixed length and there is still regularity in the data, and in the variable-length encoding stage the redundancy is removed. Hence the method used for variable-length encoding is the important element to providing randomness in the compressed data.

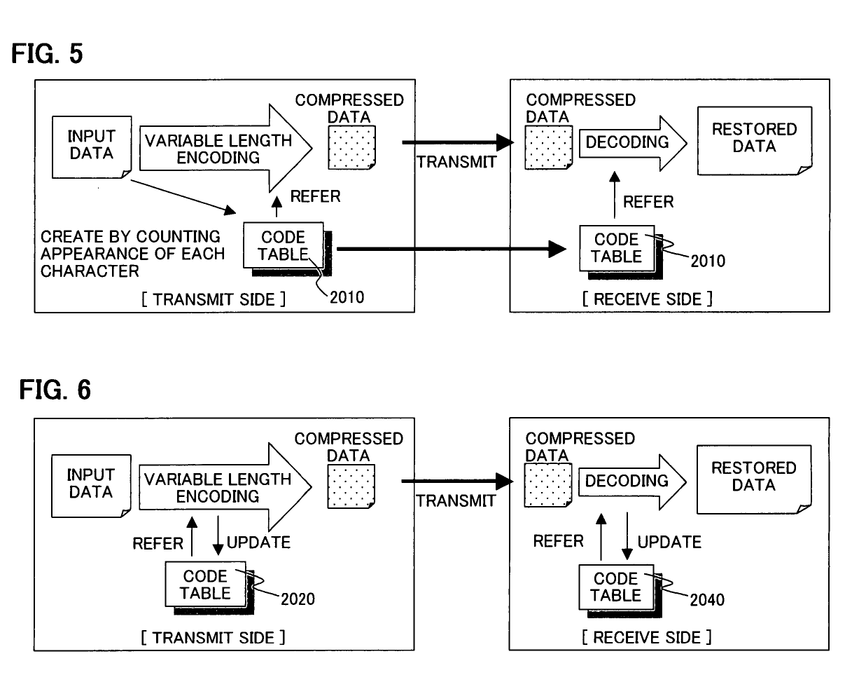

This variable-length encoding is explained below. FIG. 5 explains static encoding methods, and FIG. 6 explains a preferred dynamic encoding method of this invention. The principal methods of variable-length encoding are the static encoding method shown in FIG. 5, and the dynamic encoding method shown in FIG. 6.

As shown in FIG. 5, in static encoding methods either the data to be compressed, or a sample of the data to be compressed is input, the probabilities of appearance of characters which appear are calculated, and code words, assigned with smaller numbers of bits assigned to characters appearing more frequently, are arranged to create a code table 2010. Data is then input, and each character is converted into a code word according to the code table 2010 to perform compression encoding.

When decoding, the same code table 2010 used for compression is employed. Consequently the same code table 2010 as was used on the compression (transmission) side must be sent to the decoding side. When using a code table 2010 created from sample data, a code table must be provided for each data type. Huffman encoding and Shannon-Fano encoding are representative of static encoding methods.

On the other hand, in dynamic encoding methods as shown in FIG. 6, the data for compression is input, and while dynamically creating a code table 2020 such as described above, that is, while repeating referencing and updating, compression encoding is performed sequentially using the code table 2020 thus created. In current character encoding, the probabilities of appearance are calculated from characters in put in the past, and the code table 2020 of such assignments is used.

When decoding, similarly to the case of compression, decoding is performed while dynamically creating the code table 2040 from the restored characters. On the decoding side, the same code table 2040 as on the compression side can be reconstructed from the compression data, so that there is no need to send the code table 2020. As representative dynamic encoding methods, the dynamic Huffman encoding method is optimal, and the splay encoding method enables simple and rapid code table creation.

Next, static encoding and dynamic encoding methods are studied from the standpoint of compression methods for which deciphering is difficult. Considering the degree of difficulty of deciphering compressed data regarded as encrypted, because the compressed data comprises variable-length codes, if the positions delimiting individual characters and the code lengths are not known, deciphering is not possible.

However, in the case of static encoding the same code table is used for the entirety of the compressed data, so that code words are fixed, and deciphering becomes comparatively easy. Moreover, if the code table is acquired, the number of searches necessary for deciphering is greatly reduced, and the data can be decrypted.

On the other hand, in the case of dynamic encoding the encoding is performed while creating the code table, so that as shown in FIG. 3 the code words are not fixed. In dynamic encoding, the initial portion of the compressed data is close to the initial state of the code table, and so is easy to decipher; but when the initial portion is concealed, decoding from partway through the data becomes extremely difficult.

For this reason, in this invention, scramble data is appended to the beginning of the data for processing in order to conceal the initial portion, and a loss-less compression method employing dynamic encoding is used, to provide the compression process itself with a function for encrypting succeeding data using the preceding data, similarly to a conventional CBC mode. Thus compressed data with a high degree of randomness can be generated through data compression, and the data for processing can easily be randomized. That is, there is no need to share a common initial value on the generating side and on the restoring side, and moreover processing is simple, and processing time can be shortened.

Details of the Compression Method

Next, dynamic Huffman encoding and splay encoding are explained in detail, as dynamic encoding methods to which an aspect of this invention is applied.

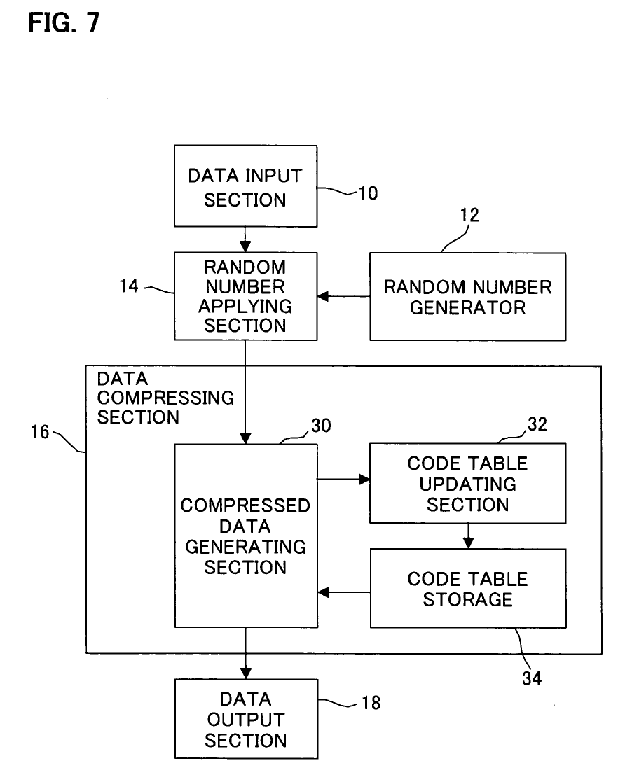

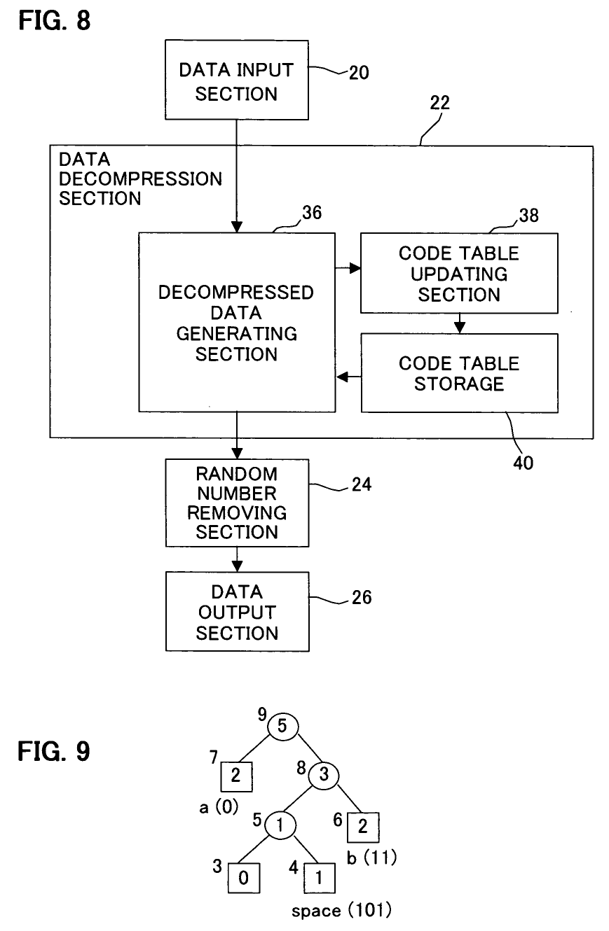

FIG. 7 is a block diagram of a first aspect of the data compression method of FIG. 1, FIG. 8 is a block diagram of a first aspect of the data decompression method of FIG. 2, and FIG. 9 through FIG. 12 explain the data compression operation of FIG. 7.

FIG. 7 and FIG. 8 show functional blocks of a data compression/decompression method, which is realized in hardware or as a program; in the respective figures, details of a compression portion 16 to which dynamic Huffman encoding is applied, and an expansion portion 22 are shown. As shown in FIG. 7, the generating side (compression side) has a data input portion 10, random number generation portion 12, random number appending portion 14, compression portion 16, and data output portion 18.

The compression portion 16 has a compression data generation portion 30, compression code table update portion 32, and compression code table holding portion 34. In this example also, a random number generated by the random number generation portion 12 is appended, by the random number appending portion 14, to the beginning of the data for processing from the data input portion 10. Then the data for processing, including the random number, is compressed by the compression portion 16 described below, and the result is output from the data output portion 18.

On the other hand, the decompression side has a data input portion 20, compressed data expansion portion 22, random number removal portion 24, and data output portion 26, as shown in FIG. 8. The compressed data expansion portion 22 has an expansion data creation portion 36, compression code table update portion 38, and compression code table holding portion 40.

In this example also, compressed data input from the data input portion 20 is expanded by the expansion portion 22 using the dynamic Huffman encoding described below, the random number at the beginning is removed by the random number removal portion 24, and the result is output from the output portion 26. These random numbers have a predetermined bit length, or a bit length specified from outside.

Next, the dynamic Huffman encoding method applied in FIG. 7 and FIG. 8 is explained, using FIG. 9 through FIG. 12. Dynamic Huffman encoding is a method of performing encoding while counting the frequency of appearance of each character in the input data, and when count values for characters change greatly, re-creating the code table. Below, this method is abbreviated as “DH” (for “dynamic Huffman”) encoding. DH encoding began to be used in the early 1980's. An FGK algorithm, as well as a V algorithm which improves on the former, have been proposed.

FIG. 9 through FIG. 12 are used in a more specific explanation. An example is explained in which, when the data stream “aa bbb cccc ddddd eeeeee fffffff gggggggg” is input, DH encoding is performed using the FGK algorithm, while creating code words. In FIG. 9 through FIG. 12, an “X” in a circle is an internal node with x number of appearances, and a “y” in a square indicates a leaf node with y number of appearances.

In the encoding procedure, initially the code tree comprises only the node with number “0”, with one leaf. The node with number “0” is a node representing all unused characters. In FIG. 9 through FIG. 12, numbers are shown on the upper-left of circles and squares.

Next, each time a character is input the count numbers for all nodes on the path leading to that character (numbers in the circles in the figures) are incremented, and a code tree is reconfigured so as to have the sibling property. The “sibling property” is the property in which the count numbers for two branches connected to one node are either the same, or are different by only one.

It has been proven that if the code tree has the sibling property is maintained, the code is a Huffman code. For example, FIG. 9 shows a tree with codes after encoding of “aa bb”; “11” is the code word of the next “b”.

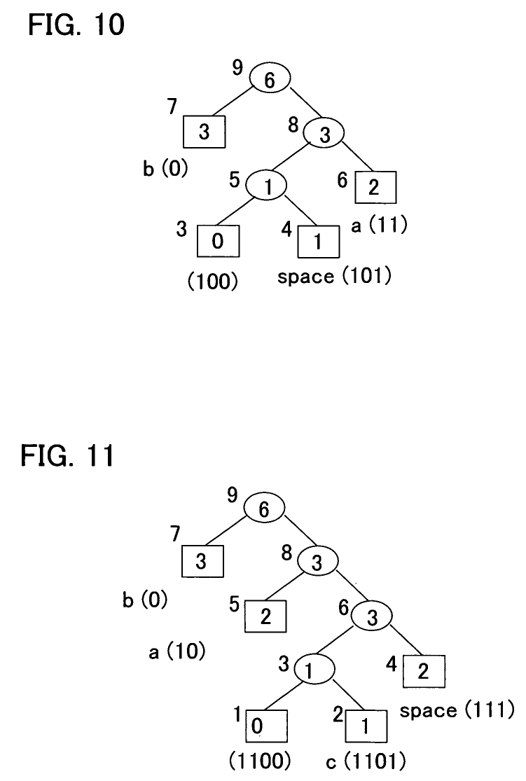

When a count number is incremented and the sibling property no longer holds, the tree form is updated by substitution to maintain the sibling property. In this substitution, for example in FIG. 9, if when the character “b” is input the count number is incremented, the sibling property no longer holds; but by substituting a leaf of character “a” for the leaf of character “b” as shown in FIG. 10 and incrementing, the sibling property is maintained.

For example, in FIG. 10 the third “b” character indicates the tree after encoding, and “101” is the code word for the next space. The form of the code tree does not change, and only the frequency count values are updated. And, “111” becomes the code word for the first “c”.

Further, when a new character k is input, the character k is encoded by the code word of the leaf with number “0”, and in addition information specifying the appearance of the character k is encoded. Together with this, the leaf with number “0” is divided into a new number “0” and the leaf of character k.

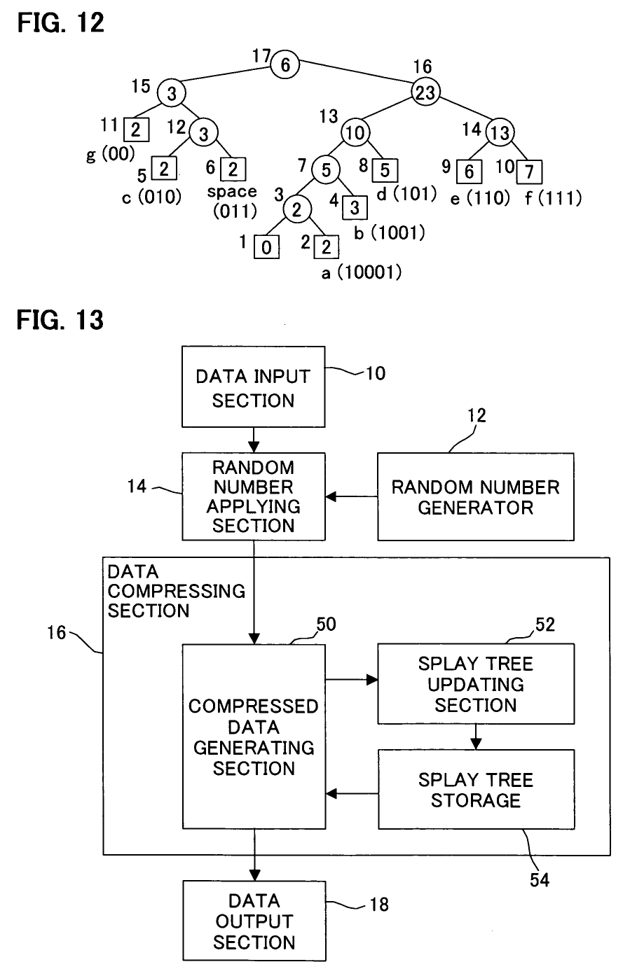

For example, FIG. 11 shows the code tree after encoding the initial character “c”. And FIG. 12 shows the configuration of the code tree after the end of input of the entire data stream described above.

In this way, characters are encoded sequentially while updating the code table (code tree), as in FIG. 9 through FIG. 12. For example, in FIG. 9 the character “a” is the code word “0”, but in FIG. 12 is the code word “10001”.

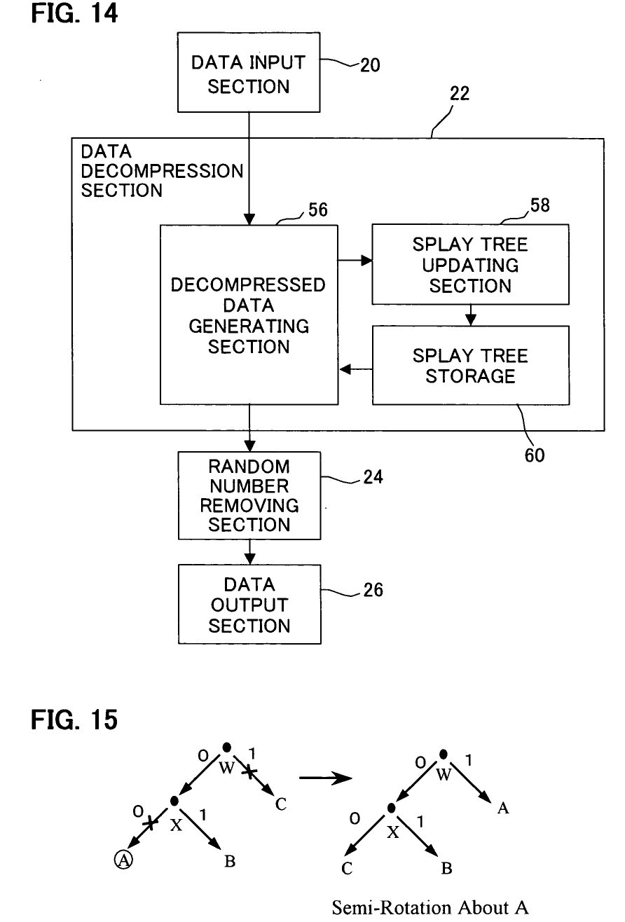

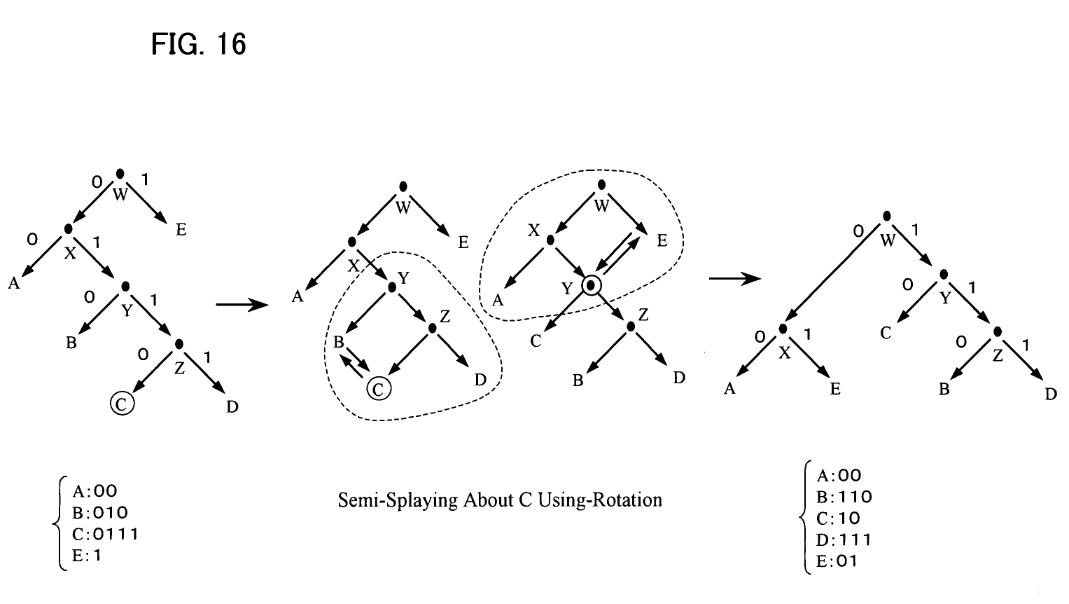

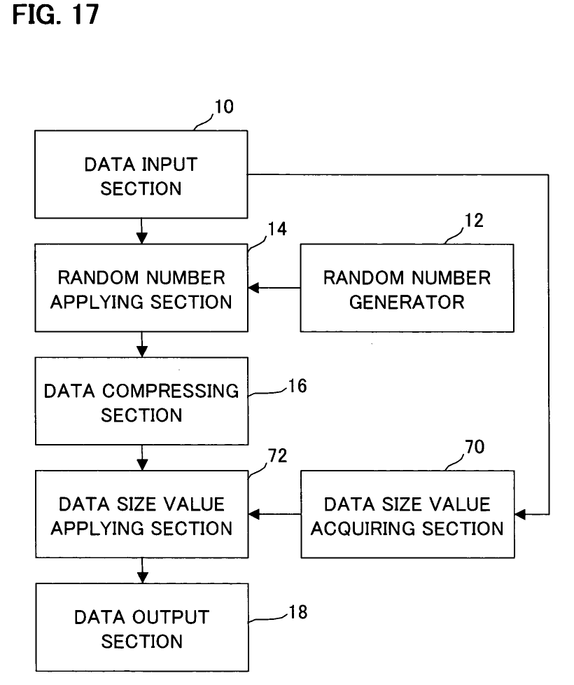

Next, a splay encoding method is explained. FIG. 13 is a block diagram of a second aspect of the data compression method of FIG. 1, FIG. 14 is a block diagram of a second aspect of the data decompression method of FIG. 2, and FIG. 15 and FIG. 16 explain the data compression operation of FIG. 13.

FIG. 13 and FIG. 14 show the functional blocks of the data compression/decompression method, which is realized in hardware or as a program; in the respective figures, details of a compression portion 16 to which splay encoding is applied, and an expansion portion 22 are shown. As shown in FIG. 13, the generating side (compression side) has a data input portion 10, random number generation portion 12, random number appending portion 14, compression portion 16, and data output portion 18.

The compression portion 16 has a compressed data generation portion 50, splay tree update portion 52, and splay tree holding portion 54. In this example also, a random number generated by the random number generation portion 12 is appended by the random number appending portion 14 to the beginning of the data for processing from the data input portion 10. The data for processing including the random number is then compressed by the compression portion 16 using splay encoding, described below, and the result is output from the data output portion 18.

On the other hand, the decompression side has a data input portion 20, compressed data expansion portion 22, random number removal portion 24, and data output portion 26, as shown in FIG. 14. The compressed data expansion portion 22 has an expanded data generation portion 56, splay tree update portion 58, and splay tree holding portion 60.

In this example also, compressed data input from the data input portion 20 is expanded by the expansion portion 22 using the splay code described below, the random number at the beginning is removed by the random number removal portion 24, and the result is output from the output portion 26. These random numbers are either of a predetermined bit length, or are of a bit length specified from outside.

Next, the splay encoding method applied in FIG. 13 and FIG. 14 is explained using FIG. 15 and FIG. 16. In splay encoding, the code tree is dynamically rearranged such that the length of a path from the root to an accessed leaf is ½, with the code table adapted to the input data. There is no counting of the number of appearances of characters as with dynamic Huffman codes, and encoding is fast and simple.

Splay trees were originally proposed as a kind of self-balancing binary search tree. In FIG. 15 and FIG. 16, the code tree is represented by a binary tree. In a binary tree there are two branches at each node, and the left and right branches correspond to the “0” and “1” of one bit. Each leaf of a binary tree is associated with a character, and the “0”s and “1”s from the leaf to the root correspond to the code word for the character.

In splay operation to rearrange the code tree, an accessed node is rearranged as a sub-tree on the right side, as shown in FIG. 15. That is, a linear list move-to-front operation is performed on the binary tree. FIG. 15 shows a basic operation for code update of the splay code, showing the update operation when A is accessed.

As shown in the example of code updating of a splay code in FIG. 16, when “c” is accessed, the code tree is updated each time such that the code length of the character appearing is shortened by ½. Hence as a result of accessing (referencing) the character “c”, the code words (A: 00, B: 010, C: 0110, D: 0111, E: 1) are updated to the code words (A: 00, B: 110, C: 10, D: 111, E: 01).

With respect to this hard-to-decipher dynamic encoding operation, the difficulty of deciphering dynamic Huffman codes and splay codes is further explained.

In dynamic Huffman encoding, code words are changed dynamically; but when the statistical properties of input data are uniform, if the input data is long, code words converge on a fixed pattern. For the same reason, deciphering becomes easy. On the other hand, in splay encoding dynamic balancing of code words is used, so that there is no convergence. Hence deciphering is difficult.

For example, in a doctoral dissertation (Mar. 13, 1997) titled “Compression and Cryptology”, S. A. Irvine of Waikato Univ. has formulated the cryptographic strengths of different compression methods. Below, descriptions in this reference relating to the cryptographic strength of Huffman codes and splay codes are discussed.

It is stated that Huffman codes are not safe, but that splay codes have sufficient strength. The strength of splay encoding as cryptographic codes is expressed as the number of attempts (number of searches) required in a brute force attack.

It is stated that, if the alphabet size (number of characters) is n, because encoding is into (2n-2)!/(n-1)! byte units, when n=256 a splay code has 3.97×10⁶⁵⁶ possible code words, and if n>14, the number of initial states to search for a 56-bit DES (Data Encryption Standard) encryption key is exceeded.

Quantitatively, the following is reasonable. If one year=1.3×10⁶ seconds and one search can be performed in 100 ns, then by operating 10,000 computers in parallel for one year, only 10¹⁷ searches can be performed. Hence it is for practical purposes not possible to use the brute force method for deciphering of splay-encoded compression data from midway through the data.

Further, it is for practical purposes difficult to increase the alphabet size arbitrarily in order to perform compression processing in one byte units. Instead, if in the modeling stage 1000 shown in FIG. 4 different code tables are assigned (this is called “adding context”) to each group to which the immediately preceding character belongs, the effect is equivalent to increasing the alphabet size, and the number of brute force searches can be sharply increased. For example, if there are 128 contexts, the alphabet size is equivalently 256×128, so that n=32 k, and deciphering by brute force becomes impossible.

Methods of applying contexts are discussed in a paper by D. W. Jones, “Application of Splay Trees to Data Compression” (Communications of the ACM, Vol. 31, No. 8, August 1988).

Second Aspect

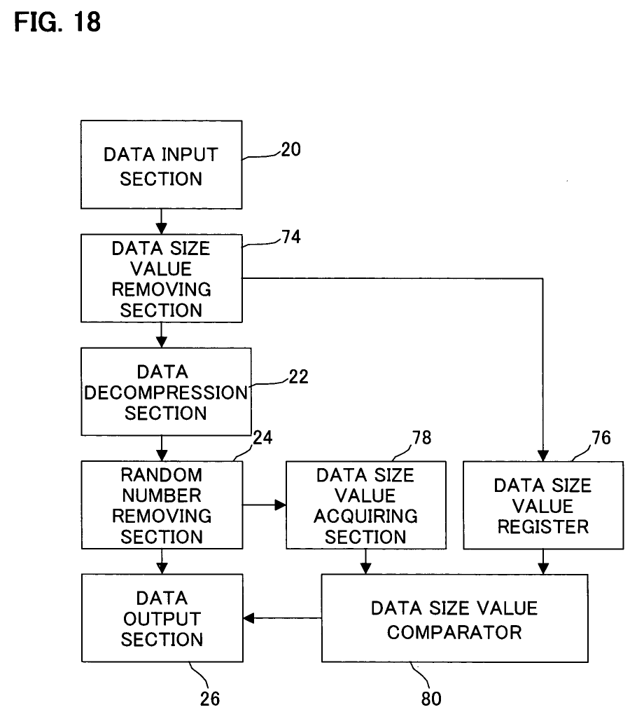

FIG. 17 is a block diagram of a second aspect of a data compression method of this invention, and FIG. 18 is a block diagram of a second aspect of a data decompression method of this invention.

FIG. 17 and FIG. 18 show the functional blocks of the data compression/decompression method, which is realized in hardware or in a program. As shown in FIG. 17, the generating side (compression side) has a data input portion 10, random number generation portion 12, random number appending portion 14, compression portion 16, and data output portion 18, and also has a data size acquisition portion 70 which acquires the size of the data (file) input to the data input portion 10, and a data size appending portion 72 which appends the acquired data size to the data compressed by the compression portion 16, and passes the result to the data output portion 18.

To explain this operation, the random number appending portion 14 appends, to the beginning of the data for processing from the data input portion 10, a random number generated by the random number generation portion 12. The data for processing including the random number is the compressed by the compression portion 16. On the other hand, the data size acquisition portion 70 acquires the size of the data (file) input from the input portion 10, and the data size appending portion 72 appends the acquired data size to either the beginning or the end of the data compressed by the compression portion 16, and passes the result to the data output portion 18. The compressed data with data size appended, is then output from the data output portion 18.

In this example also, as shown in FIG. 3, a scramble value (for example, a random number) of either a predetermined bit length or of an arbitrary specified bit length is appended to the beginning of the (input) data for processing, and while compressing the data for processing including the appended scramble value, the compression code table is updated according to the compressed data (hereafter, compressed data which has been compressed with a scramble value appended is called scrambled compressed data).

By this means, data closer to the beginning affects the modification of compression codes for later data. By using such a compression method to generate data with high randomness, the data for processing can be randomized.

On the other hand, the decompression side has a data input portion 20, compressed data expansion portion 22, random number removal portion 24, and data output portion 26, as shown in FIG. 18, and also has a data size removal portion 74 which removes the data size from the input data, a data size holding portion 76 which holds the removed data size, a data size acquisition portion 78 which calculates the data size of the data with random number removed after data expansion, and a data size comparison portion 80 which compares the data size in the data size holding portion 76 and the data size from the data size acquisition portion 78, and controls the data output portion 26.

To explain this operation, the data size is removed from the compressed data input from the data input portion 20 and is held by the data size holding portion 76; compressed data with the data size removed is expanded by the expansion portion 22, the random number at the beginning is removed by the random number removal portion 24, and the result is passed to the output portion 26.

The acquisition portion 78 calculates the data size of data after the random number is removed from the expanded data, and the data size comparison portion 80 compares the data size in the data size holding portion 76 with the data size from the data size acquisition portion 78, and controls the data output portion 26.

In this way, a data size is appended on the generating side, and on the decompression side expansion is performed after removing the data size from the input data. After expansion, the random number is removed from the beginning of the data, and the data size of the original uncompressed data is acquired. The initially removed data size is compared with the acquired data size, and if they are the same, the restored data is output.

Thus by verifying the data size, tampering can be detected. Of course, data compression can be used to generate compressed data with high randomness, and data for processing can easily be randomized. That is, there is no need to share a common initial value on the generating side and on the restoring side, processing is simple, and processing time can be shortened.

Third Aspect

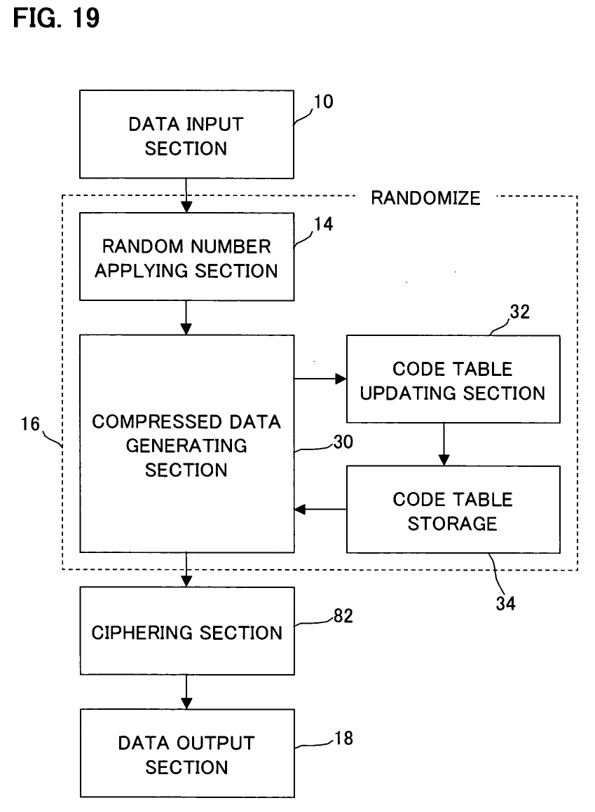

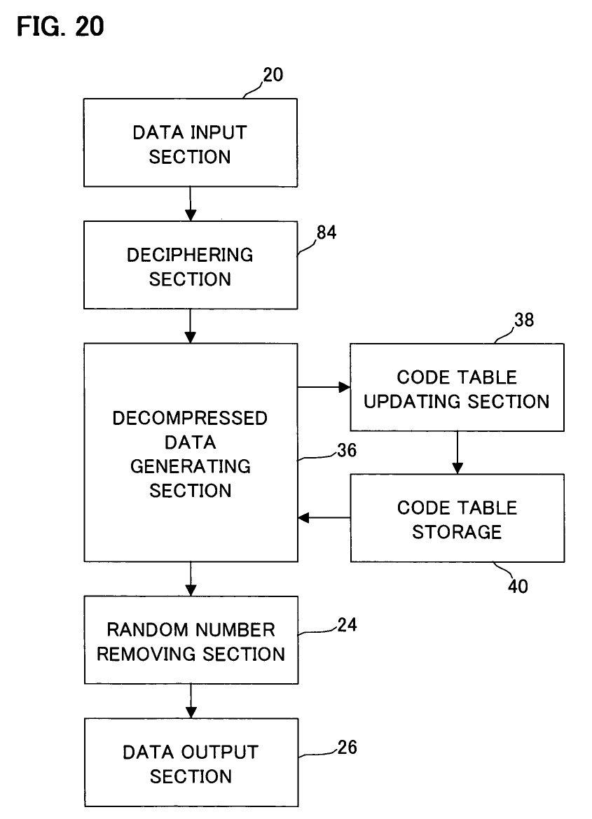

Next, an aspect is explained in which, prior to block encryption, the compression method of the first aspect is applied. FIG. 19 is a block diagram of a third aspect of a data compression method of this invention, and FIG. 20 is a block diagram of a third aspect of a data decompression method of this invention.

FIG. 19 and FIG. 20 show functional blocks of a data compression/decompression method, realized in hardware or in a program, and using, respectively, a compression portion 16 to which dynamic encoding is applied, and an expansion portion 22. As shown in FIG. 19, the generating side (compression side) has a data input portion 10, random number generation portion 12, random number appending portion 14, compression portion 16, and data output portion 18.

The compression portion 16 has a compressed data generation portion 30, compression code table update portion 32, and compression code table holding portion 34. In addition, an encryption portion 82, which performs encryption processing of compressed data, is provided between the compressed data generation portion 30 and the data output portion 18.

In this example also, the random number appending portion 14 appends, to the beginning of data for processing from the data input portion 10, a random number generated by the random number generation portion 12. After the data for processing including the random number is compressed by the above-described compression portion 16, the compressed data is encrypted by the encryption portion 82 and output from the data output portion 18.

On the other hand, the decompression side has a data input portion 20, compressed data expansion portion 22, random number removal portion 24, and data output portion 26, as shown in FIG. 20. The compressed data expansion portion 22 has an expanded data creation portion 36, compression code table update portion 38, and compression code table holding portion 40. In addition, a decryption portion 84 is provided between the data input portion 20 and expanded data creation portion 36.

In this example also, encrypted compressed data input from the data input portion 20 is decrypted by the decryption portion 84, then expanded by the expansion portion 22 using a dynamic code, and the random number at the beginning is removed by the random number removal portion 24 before output from the output portion 26.

By thus adding encryption, compressed data with stronger cryptography can be obtained. That is, while compressing the data for processing, the compression code table is updated (hereafter, compressed data which is compressed with a scramble value appended is called “scrambled compressed data”) according to compressed data. By this means, compression codes for later data are modified under the influence of data near the beginning. Then, by using block cryptography, encrypted data which is different from data with exactly the same contents can be generated.

Upon decompression, after decryption the compression code table of the normal initial state is restored, and after decompression the beginning portion, of a predetermined bit length or of a specified bit length, is removed.

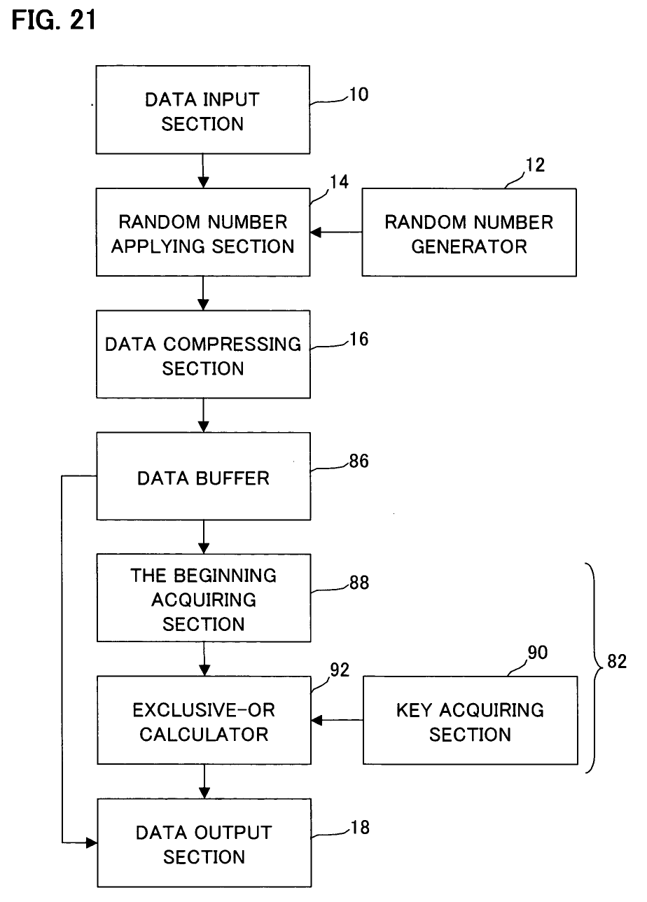

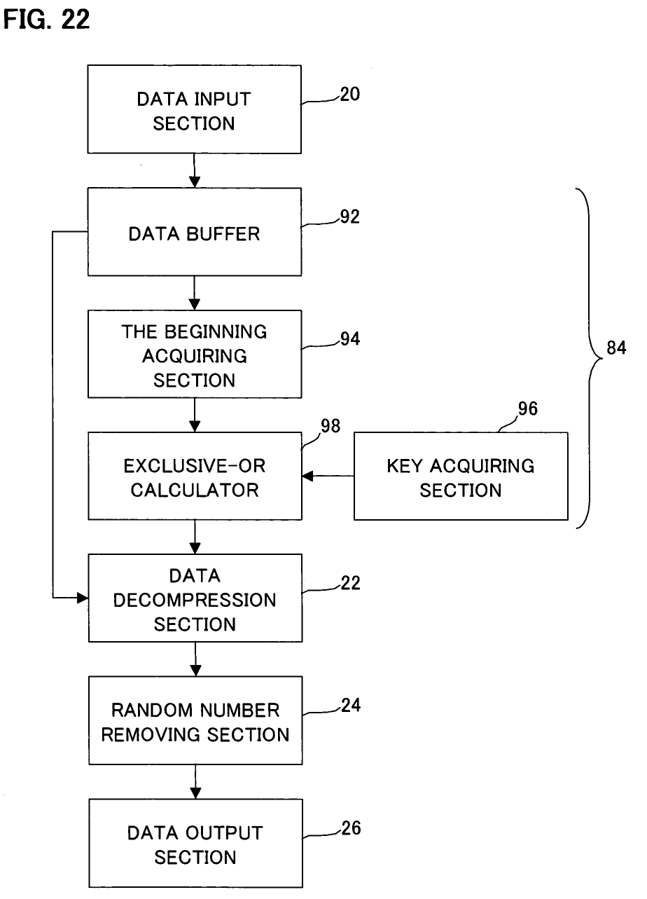

The method shown in FIG. 21 and FIG. 22 is useful for reducing the amount of encryption processing involved. That is, as a method of further reducing the amount of processing, the exclusive logical sum of the beginning of the scrambled compressed data and a bit stream acquired as a separate key is taken, so that simple expansion of the beginning portion of the scrambled compressed data is no longer possible; thus through randomizing processing the need for encryption processing itself can be eliminated.

Specifically, FIG. 21 is an example in which, in the compression configuration of FIG. 19, the encryption portion 82 comprises a data buffer 86, beginning acquisition portion 88, key acquisition portion 90, and exclusive logical sum computation portion 92. FIG. 22 is an example in which, in the configuration of FIG. 20, the decryption portion 84 comprises a data buffer portion 92, beginning acquisition portion 94, key acquisition portion 96, and exclusive logical sum computation portion 98.

As shown in FIG. 21, the beginning block of the scrambled compressed data is retrieved from the data buffer 86 by the beginning acquisition portion 88, and the exclusive logical sum calculation portion 92 takes the exclusive logical sum of this beginning block with a bit stream acquired as a separate key by the key acquisition portion 90. The data output portion 18 appends the result of the exclusive logical sum computation to the scrambled compressed data other than the beginning block from the data buffer 86, and outputs the result.

On the other hand, as shown in FIG. 22, the beginning acquisition portion 94 acquires the beginning block of input data from the data buffer 92, and the exclusive logical sum computation portion 98 takes the exclusive logical sum of this beginning block with a bit stream acquired by the key acquisition portion 96 as a separate key. The compressed data expansion portion 22 then expands the result of appending, to the beginning of the scrambled compressed data from the data buffer portion 92 other than the beginning block, this result of the exclusive logical sum calculation.

The random number removal portion 24 then removes the beginning block (random number) of the expanded data, and outputs the result from the data output portion 26. In this way, the beginning portion of the scrambled compressed data cannot be restored without using the key, and the succeeding compressed data also cannot be restored.

In this aspect, the scrambled compressed data is produced by compressing data in chainlike fashion, so that randomizing only the beginning block of the scrambled compressed data has an effect equivalent to randomizing all the data, and moreover processing is simple and the processing speed can be increased. And, randomizing processing is performed in place of complex encryption processing, so that processing is simpler, processing speeds are improved, and secrecy can be enhanced.

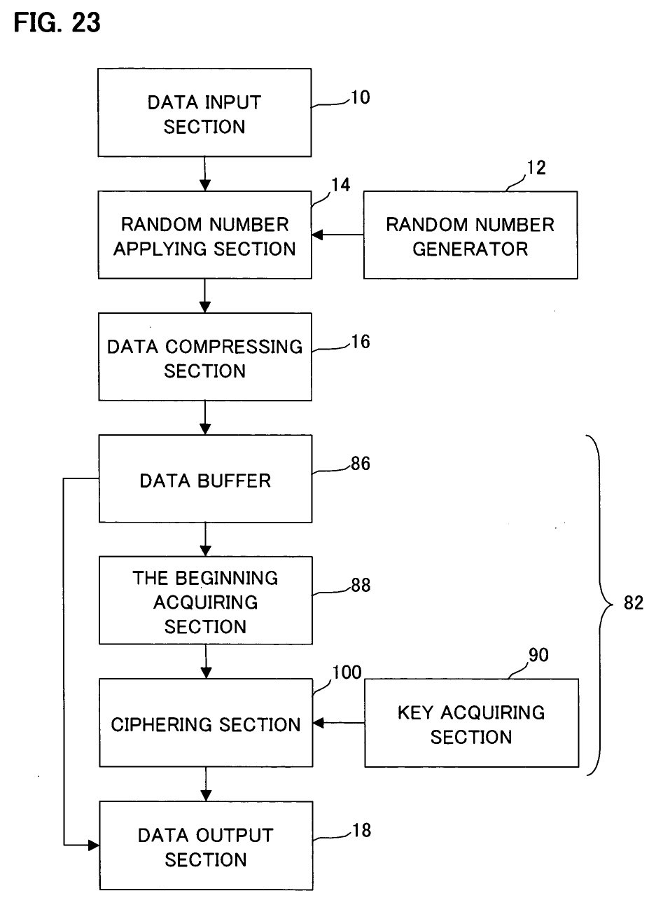

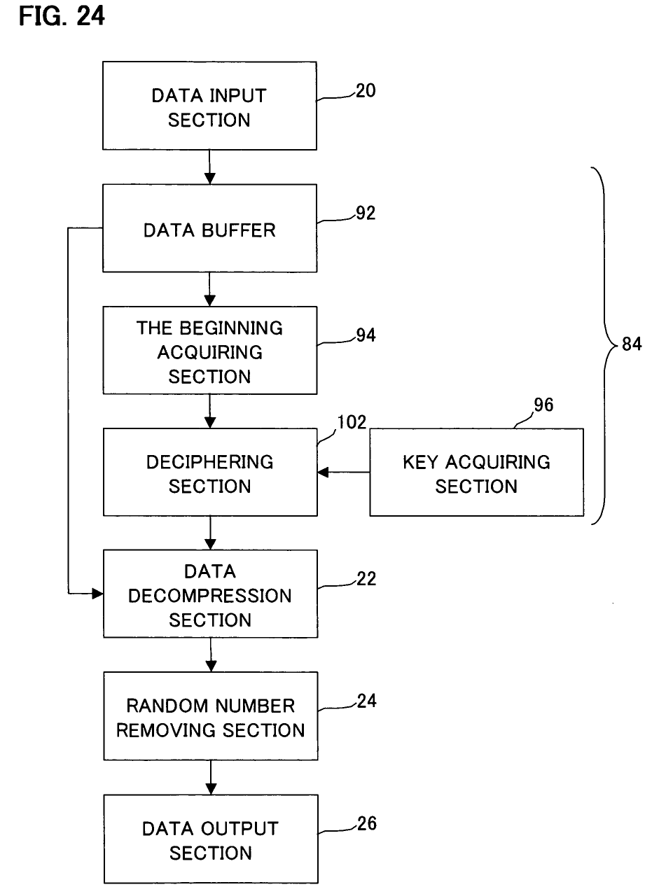

FIG. 23 and FIG. 24 show an aspect of encryption of the beginning of scrambled compressed data using an existing encryption method. Specifically, FIG. 23 is an example in which, in the compression configuration of FIG. 19, the encryption portion 82 comprises a data buffer 86, beginning acquisition portion 88, key acquisition portion 90, and low-level encryption portion 100. FIG. 24 is an example in which, in the configuration of FIG. 20, the decryption portion 84 comprises a data buffer portion 92, beginning acquisition portion 94, key acquisition portion 96, and low-level decryption portion 102.

As shown in FIG. 23, the beginning block of the scrambled compressed data is retrieved from the data buffer 86 by the beginning acquisition portion 88, and this beginning block is encrypted using a bit stream acquired by the key acquisition portion 90 as a separate key. The data output portion 18 appends the encryption result to the beginning of the scrambled compressed data from the data buffer portion 86 other than the beginning block, and outputs the result.

On the other hand, as shown in FIG. 24, the beginning acquisition portion 94 retrieves the beginning block of the input data from the data buffer portion 92, and this beginning block is decrypted by the low-level decryption portion 102, using a bit stream acquired by the key acquisition portion 96 as a separate key. The compressed data expansion portion 22 expands the result of appending this decryption result to the beginning of scrambled compressed data from the data buffer portion 92 other than the beginning block.

Then, the random number removal portion 24 removes the beginning block (random number) from the expanded data, and the result is output from the data output portion 26. The code used may be a block code or a stream code, and a public key code may be used as well. For example, triple DES is appropriate.

The beginning portion of the scrambled compressed data cannot be restored without using the key used during data generation and a decryption method corresponding to the encryption method used, nor can the following compressed data be restored.

Further, by using scrambled compression, compared with simple compression, the succeeding unencrypted data stream can also be rendered into a different bit stream even when example the same document is subjected to scrambled compression and encryption, so that secrecy is further enhanced.

In this aspect also, the scrambled compressed data is produced by compressing data in chainlike fashion, so that encrypting only the beginning block of the scrambled compressed data has an effect equivalent to encrypting all the data, and moreover processing is simple and the processing speed can be increased. And, complex encryption processing is performed on only a portion of the data, so that processing is simpler, processing speeds are improved, and secrecy can be enhanced.

Fourth Aspect

Next, an aspect is explained in which a key applied to the beginning of the scrambled compressed data shown in FIG. 21 is re-applied. For example, there are applications in which the scrambled compressed data to which a key is applied in FIG. 21 is provided to a user, and the user uses his own key, applying the key to the scrambled compressed data.

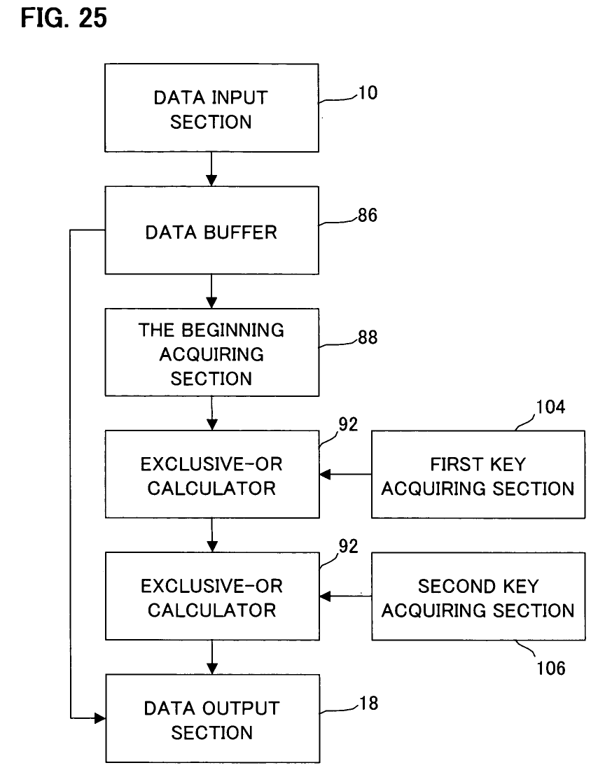

FIG. 25 is a functional block diagram of a fourth aspect in which a key applied to the beginning of scrambled data by the compression processing of FIG. 21 is re-applied.

As shown in FIG. 25, data input from the input portion 10 to the buffer portion 86 is scrambled compressed data in which the beginning of the scrambled compressed data is subjected to a logical sum operation using a first key through the processing of FIG. 21.

The beginning acquisition portion 88 acquires from the data buffer portion 86 the beginning portion of the scrambled compressed data, the exclusive logical sum with a key of which has been taken, and the exclusive logical sum computation portion 92 uses the original key from the key 1 acquisition portion 104 to take the exclusive logical sum of the beginning portion, and returns the original scrambled compressed data.

The exclusive logical sum computation portion 92 then takes the exclusive logical sum of the beginning portion of the returned scrambled compressed data with a separate key from the key 2 acquisition portion 106, and the data output portion 18 outputs the result together with the remaining succeeding compressed data.

In this example, all data is held in the data buffer 86; but the beginning portion of the data alone may be acquired, and used to overwrite the original data.

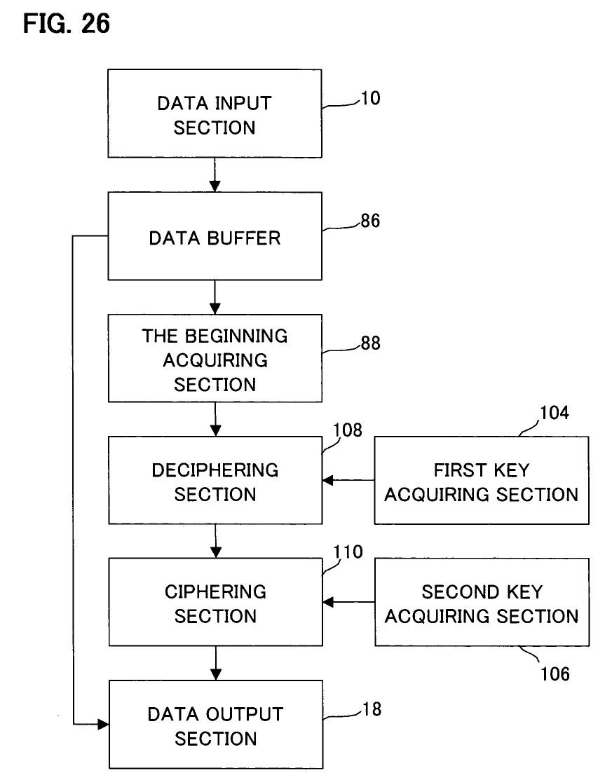

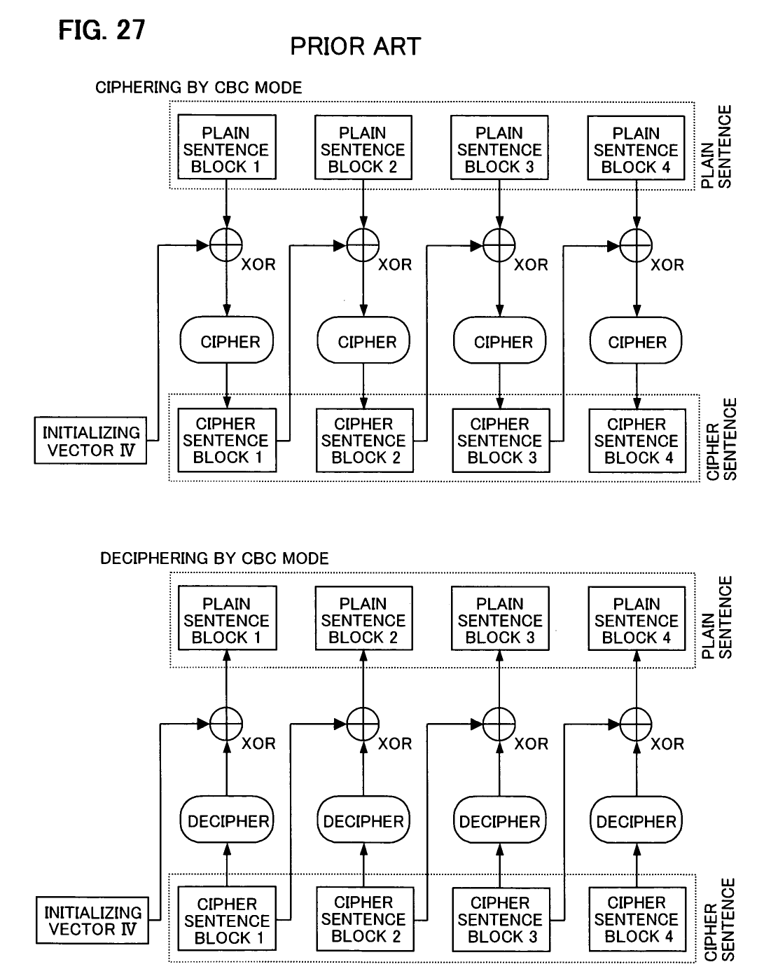

FIG. 26 is a functional block diagram of the fourth aspect of similarly re-applying encryption to the beginning of scrambled compressed data. As shown in FIG. 26, data input from the input portion 10 to the buffer portion 86 becomes scrambled compressed data, with the beginning of the scrambled compressed data encrypted using a first key, through the processing of FIG. 23.

The beginning acquisition portion 88 retrieves the beginning portion of the scrambled compressed data, encrypted using the key, from the data buffer portion 86, and the decryption portion 108 performs decryption using the original key from the key 1 acquisition portion 104, to return the data to the original scrambled compressed data.

The returned beginning portion of the scrambled compressed data is encrypted by the encryption portion 110 using another key from the key 2 acquisition portion 106, and the result is output by the data output portion 18, together with the remaining succeeding compressed data.

In this example also, the data buffer 86 holds all the data; but the beginning portion of the data alone may be acquired, and used to overwrite the original data.

In this way, a method is used in which the beginning portion of encrypted data is acquired, and a key and decryption method corresponding to the key and encryption method used on the generating side are employed to restore the original scrambled compressed data, after which the beginning portion of the restored compressed data is encrypted using another key and an encryption method, and the result is output together with the remaining succeeding compressed data.

Consequently if another key is used to randomize or encrypt only the beginning block of scrambled compressed data stored in a file device or similar, then the entirety of the scrambled compressed data can be randomized or encrypted using another key, and separate scrambled compressed data can easily be obtained.

Other Aspects

In the above-described aspects, dynamic Huffman encoding and splay encoding were explained as the data compression methods; however, other dynamic variable-length encoding methods can also be used. Similarly, each of the functional blocks of the aspects can be realized as either a program, or as hardware.

The invention can be applied, in addition to file storage and retrieval, to transmission and reception, and the data for processing can be, in addition to character strings, image data. Further, in the second aspect the data size of the uncompressed data stream is acquired; but the data size of the uncompressed data stream with the above-described scramble value appended to the beginning may be acquired.

In the above, aspects of this invention have been explained, but the invention can be variously modified within the scope of the invention, and such modifications are not excluded from the scope of the invention.

Because data compression can be used to generate compressed data with high randomness, and data for processing can be easily randomized, there is no need to share a common initial value on the generating side and on the decompression side, processing can be performed easily, and in particular the processing time for a large quantity of data can be shortened.

1. A data compression method for generating a compressed data stream from an uncompressed data stream, comprising the steps of:
appending, to the beginning of an input uncompressed data stream, a scramble value of a prescribed bit length; and,
compressing said uncompressed data stream with appended scramble value, using a dynamic variable-length encoding method.

2. The data compression method according to claim 1, further comprising the steps of:
acquiring the data size of said uncompressed data stream or of said uncompressed data stream with said scramble value appended to the beginning; and
appending said acquired data size to said uncompressed data stream with said appended scramble value.

3. The data compression method according to claim 1, further comprising the steps of:
acquiring the beginning portion of said compressed data stream;
taking the exclusive logical sum of said acquired compressed data stream beginning portion with a key of prescribed bit length; and
substituting the data stream computed by said exclusive logical sum operation for the beginning portion of said compressed data stream.

4. The data compression method according to claim 1, further comprising the steps of:
acquiring the beginning portion of or the entirety of said compressed data stream;
encrypting said acquired beginning portion of, or entirety of, said compressed data stream by using a key of prescribed bit length; and
substituting the data stream obtained by said encryption for the beginning portion of, or entirety of, said compressed data stream.

5. The data compression method according to claim 3, further comprising the steps of:
taking the exclusive logical sum of said key with the beginning portion of said compressed data stream, with said substituted beginning portion, and performing conversion into the original compressed data stream;
acquiring the beginning portion of said original compressed data stream after said conversion;
taking the exclusive logical sum of the beginning portion of said acquired compressed data stream with another key of prescribed bit length; and
substituting the data stream obtained by said exclusive logical sum operation for the beginning portion of said compressed data stream.

6. The data compression method according to claim 4, further comprising the steps of:
decrypting said beginning portion of said compressed data stream with substituted beginning portion by using a key of prescribed bit length, and performing conversion into the original compressed data stream;
acquiring the beginning portion of said original compressed data stream after said conversion;
encrypting said acquired beginning portion of the compressed data stream, using another key of prescribed bit length; and
substituting the data stream obtained by said encryption for the beginning portion of said original compressed data stream.

7. The data compression method according to claim 1, wherein said compression step comprises the steps of:
generating said compressed data according to a code table for compression, and
updating said code table according to said compressed data stream.

8. The data compression method according to claim 7, wherein said code table is a splay tree configuration.

9. A data decompression method, for generating the original uncompressed data from a compressed data stream generated according to claim 1, comprising the steps of:
decompressing said compressed data stream using said dynamic variable-length encoding method; and
removing the scramble value at the beginning of said decompressed data stream, and storing said uncompressed data.

10. A data decompression method, for generating the original uncompressed data from a compressed data stream generated according to claim 2, comprising the steps of:
removing said data size from said compressed data stream;
decompressing said compressed data stream with data size removed using said dynamic variable-length encoding method;
removing said scramble value at the beginning of said decompressed data stream;
computing the data size of said decompressed data stream or of said compressed data stream;
comparing said removed data size with said computed data size; and,
outputting said decompressed data, with scramble value removed, according to said comparison result.

11. A data decompression method, for generating the original uncompressed data from a compressed data stream generated according to claim 3, comprising the steps of:
acquiring the beginning portion of said compressed data stream;
taking the exclusive logical sum of said acquired beginning portion of the compressed data stream, and a key of prescribed bit length;
substituting the data stream obtained by said exclusive logical sum operation for the beginning portion of said compressed data stream;
decompressing said substituted compressed data stream using said dynamic variable-length encoding method; and,
removing the scramble value at the beginning of said decompressed data stream, and restoring said uncompressed data.

12. A data decompression method, for generating the original uncompressed data from a compressed data stream generated according to claim 4, comprising the steps of:
acquiring the beginning portion of, or the entirety of, said compressed data stream;
decrypting said acquired beginning portion of, or entirety of, the compressed data stream, using a key of prescribed bit length;
substituting said decrypted data stream for the beginning portion of, or entirety of, said compressed data stream;
decompressing said substituted compressed data stream using said dynamic variable-length encoding method; and
removing the scramble value at the beginning of said decompressed data stream, and storing said uncompressed data.

13. The data decompression method according to claim 9, wherein said decompression step comprises the steps of:
generating said decompressed data according to a code table for expansion; and
updating said code table according to said decompressed data stream.

14. The data decompression method according to claim 13, wherein said code table is a splay tree configuration.

15. A data compression program, for generating a compressed data stream from an uncompressed data stream, comprising:
program data to append a scramble value of a prescribed bit length to the beginning of an input uncompressed data stream; and,
program data to compress said uncompressed data stream with appended scramble value, using a dynamic variable-length encoding method.

16. The data compression program according to claim 15, further comprising:
program data to acquire the data size of said uncompressed data stream or of said uncompressed data stream with appended scramble value; and
program data to append said acquired data size to said uncompressed data stream with scramble value appended.

17. The data compression program according to claim 15, further comprising:
program data to acquire the beginning portion of said compressed data stream;
program data to take the exclusive logical sum of said beginning portion of the compressed data stream with a key of prescribed bit length; and
program data to substitute the data stream obtained by said exclusive logical sum operation for the beginning portion of said compressed data stream.

18. The data compression program according to claim 15, further comprising:
program data to acquire the beginning portion of, or the entirety of, said compressed data stream;
program data to perform encryption on the beginning portion of, or the entirety of said compressed data stream thus acquired, using a key of prescribed bit length; and
program data to substitute the data stream obtained by said encryption for the beginning portion of, or entirety of, said compressed data stream.

19. The data compression program according to claim 17, further comprising:
program data to take the exclusive logical sum of said key and said beginning portion of said compressed data stream with beginning portion substituted, performing conversion into the original compressed data stream;
program data to acquire the beginning portion of said original compressed data stream after conversion;
program data to take the exclusive logical sum of said acquired beginning portion of the compressed data stream with another key of prescribed bit length; and
program data to substitute the data stream obtained by said exclusive logical sum operation for the beginning portion of said original compressed data stream.

20. The data compression program according to claim 18, further comprising:
program data to decrypt said beginning portion of said compressed data stream with beginning portion substituted using said key, for performing conversion into the original compressed data stream;
program data to acquire the beginning portion of said original compressed data stream after said conversion;
program data to encrypt said acquired beginning portion of the compressed data stream using another key of a prescribed bit length; and
program data to substitute the data stream obtained by said encryption for the beginning portion of said original compressed data stream.

21. The data compression program according to claim 15, wherein said compression program data comprises:
program data to generate said compressed data according to a code table for compression, and
program data to update said code table according to said compressed data stream.

22. The data compression program according to claim 21, wherein said code table is a splay tree configuration.

23. A data decompression program, for decompressing a compressed data stream generated according to claim 15, comprising:
program data to decompress said compressed data stream using said dynamic variable-length encoding method; and
program data to remove a scramble value from the beginning of said decompressed data stream, and to decompress said uncompressed data stream.

24. A data decompression program, for decompressing a compressed data stream generated according to claim 16, comprising:
program data to remove said data size from said compressed data stream;
program data to decompress said compressed data stream with data size removed using said dynamic variable-length encoding method;
program data to remove the scramble value at the beginning of said decompressed data stream;
program data to compute the data size of said decompressed data stream or of said compressed data stream;
program data to compare said removed data size with said computed data size; and
program data to output said decompressed data with scramble value removed, according to said comparison result.

25. A data decompression program, for decompressing a compressed data stream generated according to claim 17, comprising:
program data to acquire the beginning portion of said compressed data stream;
program data to take the exclusive logical sum of said acquired beginning portion of the compressed data stream and a key of prescribed bit length;
program data to substitute the data stream obtained by said exclusive logical sum operation for the beginning portion of said compressed data stream;
program data to decompress said substituted compressed data stream using said dynamic variable-length encoding method; and,
program data to remove the scramble value at the beginning of said decompressed data stream, to decompress said uncompressed data.

26. A data decompression program, for decompressing a compressed data stream generated according to claim 18, comprising:
program data to acquire the beginning portion of, or entirety of, said compressed data stream;
program data to decrypt said acquired beginning portion of, or entirety of, the compressed data stream using a key of prescribed bit length;
program data to substitute the data stream obtained by said decryption for the beginning portion of, or entirety of, said compressed data stream;
program data to decompress said substituted compressed data stream using said dynamic variable-length encoding method; and
program data to remove the scramble value at the beginning of said decompressed data stream, to decompress said uncompressed data.

27. The data decompression program according to claim 23, wherein said expansion program data comprises:
program data to generate said decompressed data stream according to a code table for expansion; and
program data to update said code table according to said decompressed data stream.

28. The data decompression program according to claim 27, wherein said code table is a splay tree configuration.

29. The data conversion method comprising the steps of:
taking the exclusive logical sum of a key with a beginning portion of compressed data stream with a substituted beginning portion, that is compressed said uncompressed data stream with appended scramble value in a beginning portion of uncompressed data stream, using a dynamic variable-length encoding method, took the exclusive logical sum of said compressed data stream beginning portion with a key of prescribed bit length, and substituted the data stream computed by said exclusive logical sum operation for the beginning portion of said compressed data stream, and performing conversion into the original compressed data stream;
acquiring the beginning portion of said original compressed data stream after said conversion;
taking the exclusive logical sum of the beginning portion of said acquired compressed data stream with another key of prescribed bit length; and
substituting the data stream obtained by said exclusive logical sum operation for the beginning portion of said compressed data stream.

30. The data conversion method comprising the steps of:
decrypting said beginning portion of said compressed data stream with substituted beginning portion, that is compressed said uncompressed data stream with appended scramble value in a beginning portion of uncompressed data stream, using a dynamic variable-length encoding method, encrypted said beginning portion of, or entirety of, said compressed data stream by using a key of prescribed bit length, and substituted the data stream obtained by said encryption for the beginning portion of, or entirety of, said compressed data stream by using a key of prescribed bit length, and performing conversion into the original compressed data stream;
acquiring the beginning portion of said original compressed data stream after said conversion;
encrypting said acquired beginning portion of the compressed data stream, using another key of prescribed bit length; and
substituting the data stream obtained by said encryption for the beginning portion of said original compressed data stream.

31. The data conversion program comprising:
program data to take the exclusive logical sum of a key with a beginning portion of compressed data stream with a substituted beginning portion, that is compressed said uncompressed data stream with appended scramble value in a beginning portion of uncompressed data stream, using a dynamic variable-length encoding method, took the exclusive logical sum of said compressed data stream beginning portion with a key of prescribed bit length, and substituted the data stream computed by said exclusive logical sum operation for the beginning portion of said compressed data stream, and performing conversion into the original compressed data stream;
program data to acquire the beginning portion of said original compressed data stream after said conversion;
program data to take the exclusive logical sum of the beginning portion of said acquired compressed data stream with another key of prescribed bit length; and
program data to substitute the data stream obtained by said exclusive logical sum operation for the beginning portion of said compressed data stream.

32. The data conversion program comprising:
program data to decrypt said beginning portion of said compressed data stream with substituted beginning portion, that is compressed said uncompressed data stream with appended scramble value in a beginning portion of uncompressed data stream, using a dynamic variable-length encoding method, encrypted said beginning portion of, or entirety of, said compressed data stream by using a key of prescribed bit length, and substituted the data stream obtained by said encryption for the beginning portion of, or entirety of, said compressed data stream by using a key of prescribed bit length, and performing conversion into the original compressed data stream;
program data to acquire the beginning portion of said original compressed data stream after said conversion;
program data to encrypt said acquired beginning portion of the compressed data stream, using another key of prescribed bit length; and
program data to substitute the data stream obtained by said encryption for the beginning portion of said original compressed data stream.
